(19) United States
(12) Patent Application Publication
(10) Pub. No.: US 2007/0011058 A1
(43) Pub. Date: Jan. 11, 2007

(54) Mapping of order information in heterogeneous point-of-sale environments

(75) Inventor: Roger Dev, Portsmouth, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: NextChoice Systems, Inc., Portsmouth, NH (US)

(21) Appl. No.: 11/471,969

(22) Filed: Jun. 19, 2006

Related U.S. Application Data
(60) Provisional application No. 60/692,030, filed on Jun. 17, 2005.

(51) Int. Cl. G06Q 30/00

(52) U.S. Cl. 705/26

(57) ABSTRACT

A mapping system receives information from a standardized order input system and maps or translate the order information into the proper format and syntax required for a vendor's receiving system. In this manner, a consumer may view and utilize a standardized ordering interface while a vendor may utilize their existing and varied order receiving systems located a various order fulfillment locations.

### CROSS-REFERENCE TO RELATED APPLICATIONS

This application claims the benefit of U.S. Provisional Application Ser. No. 60/292,030, filed Jun. 17, 2005 incorporated fully herein by reference.

### TECHNICAL FIELD

The present invention relates, generally, to purchasing systems and methods and more particularly, to a semantic and syntactic mapping system for integration between a standardized input system and a plurality of receiving systems having different architectures, data structures and/or configurations.

### BACKGROUND INFORMATION

In any environment involving transactions of goods or services, it is necessary to unambiguously represent the items being bought or sold in order to accurately deliver to a customer the appropriate product and keep track of inventory. Typically, items being bought or sold do not come in only one shape or size and therefore such transactions must identify not only the item but also one or more modifiers such as size, color, flavor, etc. Computer systems make this process quite efficient.

Many of these computer systems employ software that represents each item being ordered or sold with a number of valid semantic descriptions that indicates the item's hierarchical structure, grouping(s) or modifier(s) (e.g., options, qualifiers, descriptors). For example, a hamburger can be grouped with sandwiches and modified using options that hold onions or add mustard, and a shirt may be grouped with apparel and modified according to size, color, and style. Such mapping techniques work effectively with most order processing systems where the input system (or user) knows how to define the goods so that the receiving system accurately represents the item being bought or sold. In other words, most environments are homogenous, with an input system expecting to communicate with a single type of receiver.

However, one can imagine applications where the input system may need to communicate with a variety of receiving systems, each representing similar items with different semantic descriptions. For example, a specific product may be available at a variety of different stores or different store locations that each uses a different mapping system. Such is the case when trying to implement a self-service ordering system that must be consistent or uniform across all store locations while point-of-sale systems in various stores are different and utilize varied protocols and syntax.

There are two challenges faced when trying to modify the existing homogenous mapping technology into a heterogeneous environment necessary to implement these types of applications. First, a standard input system must be able to communicate with any given back-end or receiving system such as a point-of-sale system. Second, the mapping system must have the ability to map a valid semantic description of a set of items used by the input system to another valid semantic description expected by the receiving system.

The first problem, otherwise referred to as the problem of syntactic mapping, is well known, and can be handled with drivers or interface objects that know the appropriate methods and protocols to interface to a given type of back-end system. However, the second challenge, referred to as the problem of semantic mapping, is not so easily resolved.

The problem of semantic mapping does not lend itself to a hard-coded solution because semantic representations of items are tied both to the architecture of the receiving system and the configuration of item definitions within the ordering system. Thus, a novel approach is required to allow for semantic mapping in heterogeneous environments.

### SUMMARY

The present invention provides a semantic mapping facility that converts the order-item semantics used within a particular input system to the semantics used within a particular receiving system. It also facilitates secondary one-to-one mapping between an item name in the receiving system and a tag used by the input system to reference that item, thereby avoiding lookups downstream and providing the order information in the most efficient form and in the proper format to the receiving system and those using the receiving system.

The intent is to provide a map between a standard input system and receiving systems, such that all adaptations are data-driven. Multiple mappings can be used for the same item definition thereby allowing the same item to be used for vendors with different point of sale systems or with different point of sale menu definitions at different vendor locations. Vendor receiving system attributes are used to select the appropriate mapping method for a given vendor receiving system and ordered item and modifier tags are presented in their most consumable forms (e.g., keys to the Menu-item-table, PLU codes, etc.)

The present invention features an order mapping system comprising an order input system having a user interface, for receiving an order of one or more items from a user, and for providing an order data stream. The order data stream includes at least order information providing an indication of the one of more items ordered by the user and a vendor order processing system identifier that identifies the vendor order processing system in use by a vendor who will fulfill said user's order.

The present invention couples to a vendor order processing system in use by the vendor who will fulfill the user's order, for receiving vendor order processing system formatted order data and for providing at least a visual indication of an order to be fulfilled. An order mapping system which is coupled to the order input system and to the vendor order processing system in use by said vendor who will fulfill said user's order, receives the order data stream including the vendor order processing system identifier, and responsive to said vendor order processing system identifier, converts the order information into the vendor order processing system formatted order data for use by the vendor order processing system in use by the vendor who will fulfill the user's order.

In the preferred embodiment, the order information includes at least an item identifier and may also include at least one item modifier. The at least one item modifier may be selected from the group consisting of, for example only: item type, item size, item color, item flavor, the addition of an element to the item, the quantity of the addition of an element to the item, the removal of an element normally found with the item, and the selection of an element accompanying the item from a preselected group of elements.

The vendor order processing system may be a point-of-sale system which may or may not be capable of tracking item inventory for the vendor as well as purchases by a user. The point-of-sale system may also include a visual indication on an electronic display screen of the order to be fulfilled and/or a printed indication of the order to be fulfilled.

### BRIEF DESCRIPTION OF THE DRAWINGS

These and other features and advantages of the present invention will be better understood by reading the following detailed description, taken together with the drawings wherein:

FIG. 1 is a block diagram of the present invention which interfaces with a standardized ordering system and provides a converted order to any type of receiving system;

FIG. 2 is a table illustrating an exemplary correspondence between input item descriptions and receiver item descriptions in an exemplary system consistent with the present invention;

FIG. 3 is a system diagram illustrating an exemplary map order service flow in an exemplary system consistent with the present invention;

FIG. 4 is a flowchart illustrating an exemplary method for processing rules in an exemplary system consistent with the present invention;

FIG. 5 is a system diagram illustrating an exemplary structure of the syntactic mapping structure in an exemplary system consistent with the present invention; and

FIG. 6 is a diagram illustrating an exemplary order mapping service integration with a vendor receiving system in an exemplary order processing system consistent with the present invention.

### DETAILED DESCRIPTION OF THE PREFERRED EMBODIMENTS

This invention addresses the problems associated with creating a heterogeneous mapping structure in order to effectuate an order-processing environment that utilizes a standard input system communicating with multiple different receiving systems, regardless of the architecture, configuration or syntax of each receiving system. This invention allows for both the semantic and syntactic mapping of items in such systems. An exemplary system will be described with reference to the quick-serve restaurant industry although this is for exemplary purposes only and is not to be considered a limitation of the present invention as the present invention can also be utilized in any system for ordering and processing any type of item.

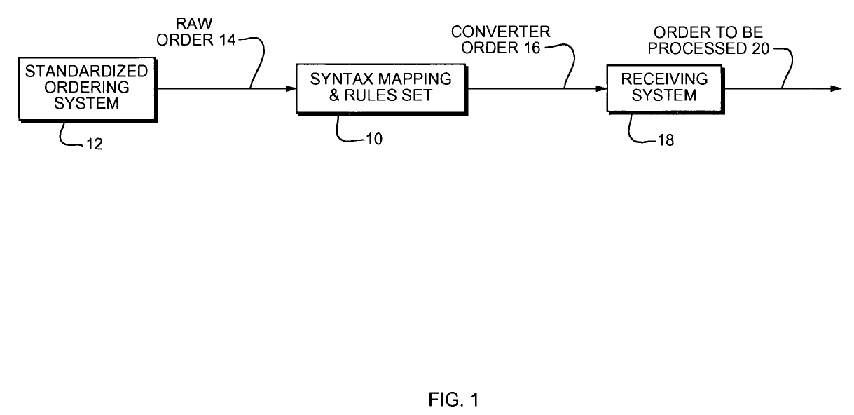

The mapping system 10, FIG. 1, according to the present invention, receives raw order information from a standardized ordering system 12. In the preferred embodiments, the standardized ordering system 12 is preferably a self service ordering system which allows a consumer to order items themselves without the need for intervention by another person. Such ordering systems are finding increased popularity in restaurants and fast food establishments as well as other wholesale and retail establishments. These ordering systems allow the consumer to enter and customize their order which is then processed for pick up by or delivery to the consumer. The order processing system may be located at the restaurant or fast food establishment or alternatively, may be located remotely from the restaurant. Remote entering of an order may be accomplished utilizing a computer with Internet access or on a telephone or other electronic device.

The mapping system 10, of the present invention takes the raw order information 14 from the standardized ordering system 12 and converts it to provide a converted order 16 in accordance with the particular requirements and syntax of the receiving system 18. In the preferred embodiment, the receiving system 18 is a point of sale system installed at the restaurant, store or other event or location.

As is well known in the art, such point-of-sale systems serve not only to process consumer orders but also to track inventory, consumer preferences and the like. In addition, and sometimes most importantly, such point-of-sale systems provide the order to be processed 20 in a form or format that is familiar to those individuals who will be processing the order. Thus, the mapping system 10 of the present invention provides a novel method for allowing a standardized ordering system 12 to provide a familiar order to be processed 20 without the need for being concerned with a particular receiving system 18.

Although the present invention illustrates the mapping system 10 separate and apart from both the standardized ordering system 12 in the receiving system 18, this is not a limitation of the present invention as the mapping system 10 may be part of the standardized ordering system 12 or the receiving system 18.

### Semantic Mapping

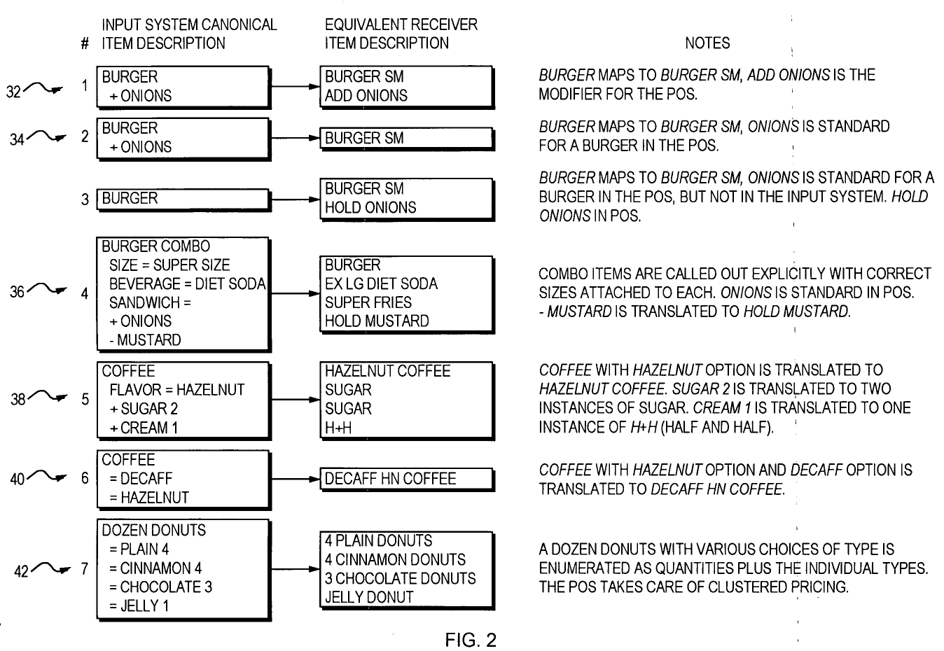

The semantic mapping capabilities in a system consistent with the present invention will be described. The semantics for a particular menu item used by the input system must be translated by the mapping system 10 into the semantics used by a restaurant's particular receiving system for that same item. One way to accomplish this task is to provide one-to-one mapping between the input system identifier and the restaurant identifier for the same item. Some of the capabilities of a one to one mapping system are enumerated below with reference to FIG. 2.
Map one item name to a different item name (e.g., Burger→Burger SM), 34;
Map a modifier type (such as the “+” modifier) to a modifier tag (e.g., +Onions→Add Onions), 32;
Map a modifier type (such as the “+” modifier) to a null modifier (e.g., +Onions→<None>), 34;
Map a single item tag to multiple item tags (e.g., Burger Combo→Burger, Fries, Drink), 36;
Map a combination of an item tag and modifiers to multiple specific item tags, possibly with modifiers (e.g., Burger Combo,=Super Size,=Diet Soda→Burger, Ex Lg Diet Soda, Super Fries), 36;
Map an item or modifier with a quantity to multiple items of the same type (e.g., Sugar:2→Sugar, Sugar), 38;
Map an item with a particular set of modifiers to a single item definition (e.g., Coffee,=Decaff, =Hazlenut→Decaff HN Coffee), 40;
Map an item with a set of quantified modifiers to a set of quantified items (e.g., Dozen Donuts,=Plain:4,=Cinnamon:4,=Chocolate:3,=Jelly: 1→4 Plain Donuts, 4 Cinnamon Donuts, 3 Chocolate Donuts, 1 Jelly Donut), 42.

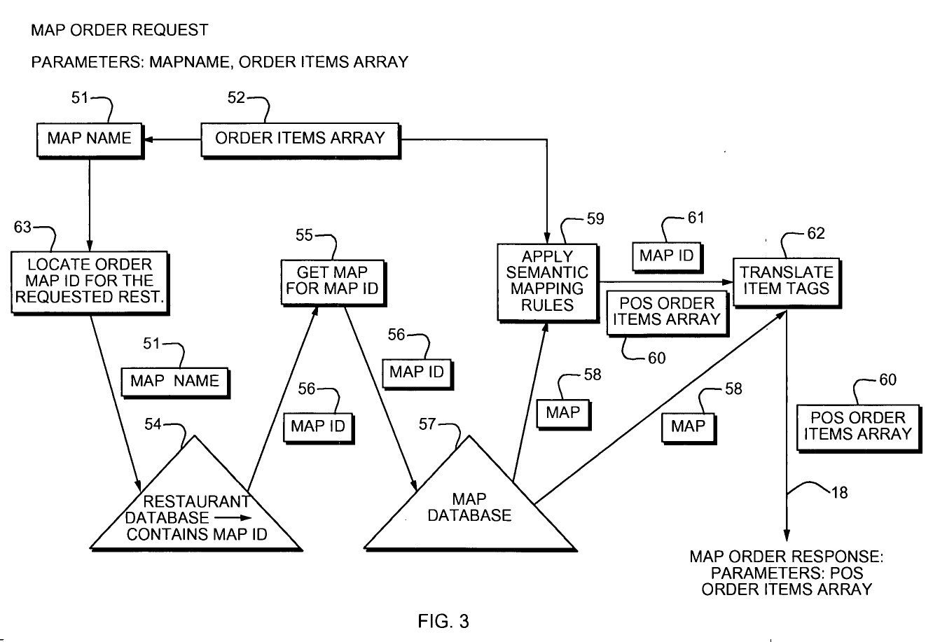

An exemplary method of implementation for the above capabilities will be described below with reference to FIG. 3.

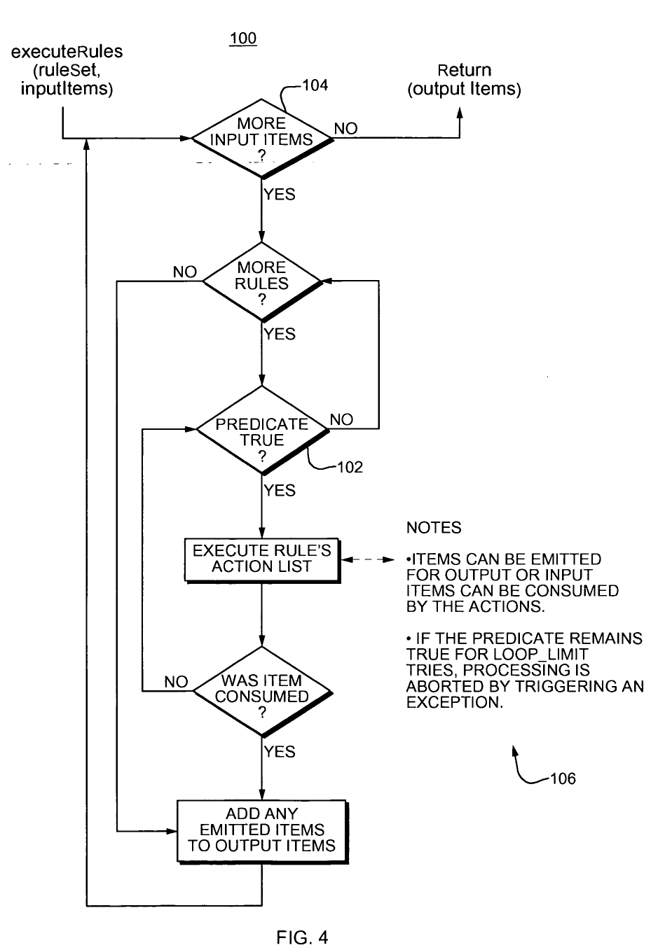

The standardized ordering system 12 provides raw order information 12 in the form of an order items array 52 which includes information as to the location from which the order items are to be delivered or to which the order items are to be picked up. Using the location information from the order items array 52, the location ID, or mapName 51 is used to access a map ID 56 in the restaurant database 54. The term “map” is sued in the context of conversion or “mapping” and not physical placement or location. Since each restaurant can share “maps” with other restaurants, a location identifier alone cannot be used to retrieve a map. For example, the correct map is determined by inspecting the location attribute: mapName. If mapName is present, then the indicated map name is used to locate the record (a map ID) in the MI_MAP_TBL (see FIG. 4, block 73) with that name. The map ID for that record is used for all transactions within the location. If no mapName is present, the record for mapName=“Default” will be chosen. The map ID can be cached for the duration of the process. It is contemplated that changing maps would be an infrequent activity and is likely to require a system restart.

Next, a set of mapping rules, or rule set, for a particular location are retrieved using the map ID, shown by block 57. The rule set is built by locating any rules for the item and each of its containment parents (see block 59). Parents are the containing categories (e.g., Cola→Soft Drinks→Beverages→Menu Items). In this example, the rule set is built starting with the rules for Cola, then appending the rules for Soft Drinks, then Beverages and then Menu Items. Menu items is the root container for all types of categories. Thus, the rules attached to more specific items are earlier in the list, with the most general rules last. This has the effect of creating an inheritance structure.

FIG. 4 illustrates one example of a rules processing method 100. Rules are composed of a predicate and an action-list, and are executed based on the order of the rule set. Each rule is executed by evaluating the rule's predicate and if the predicate is TRUE, act 102, executing each of the actions in the rule's action-list and then, repeating the process act 104 if the predicate remains true, 102. Rule processing is terminated when there is no more input to act upon, act 104 (i.e. it has all been consumed), or a max repeat count act 106 is reached in which case an exception is triggered. FIG. 4 thus illustrates the processing logic for executing a set of mapping rules against a list of input items, and corresponds to block 59.

The predicate is formed as an expression made up of Boolean terms combined using the binary operators ‘and’ and ‘or’, the unary operator ‘not’ and parentheses to control the order of evaluation. The following are exemplary Boolean functions that could be supported within the terms of the predicate.

```
hasModifier(<modType><modName>)
  modType:= ‘+’ | ‘−’ | ‘=’
  modName := <any>#(e.g., ‘Onions’)
    Example: hasModifier(‘+Onions’)
ofType(<itemName>)
  itemName is matched hierarchically (i.e. if it matches
  the item or any of its containment parents).
    Example: hasModifier(‘− Ketchup’) and
    ofType(‘Combo’)
firstTime( )
  Returns true if this is the first time the rule is
  invoked. Used to create rules that only execute once
  even though they may not consume their required input.
```

The following string functions can be used in conjunction with the comparators (“==”, “!=”) and a reference value to form Boolean expressions that can be used within a predicate.

```
selectionOf(<groupName>) -
  Used to read the value of a “Pick1” type option.
  <groupName> is the name of the Option Group
    Examples:
      selectionOf(“Size”) == “Large” and
      ofType(‘Combo’)
      selectionOf(“Dressing”) == “French”
```

The action list can contain multiple actions. Each action is defined by an action type and a single parameter (e.g., <action> <parameter>; <action> <parameter>; . . . ). A (%) sign around a parameter indicates that the parameter is a substitution variable (i.e., <action> %variable%). Exemplary action types and substitution variables, along with their definitions, are provided below.

Action types include:
Emit <item-string>—Add an item string to the output stream. Alternate forms Emit2 . . . Emit9 can be used to indicate that an item should be emitted at a lower priority (e.g., later in the list). Emit with no digit implies that the item is emitted at the highest priority.
EmitMod <item-string>—Add a modifier to the latest item in the output stream
Consume <item-string>—Remove an item from the input stream. The item-string can either be an item type name (e.g., Burger) or a name followed by a vertical bar followed by a quantity (e.g., Burger|3
ConsumeMod <item-string>—Remove a modifier from the item in the input stream. The item-string can be either the modifier (e.g, +Onions) or the modifier plus a vertical bar plus a quantity (e.g., +Sugar|2).

Substitution variables include:
itemName—the name of the item for which this rule is being executed (e.g., “French Fries”)
modType—the type of the current modifier (i.e. the last modifier selected by the hasModifier( ) predicate function—one of the modifiers that caused the rule to fire).
Returns “+”, “−”, or “=”.
modName—the current modifier without the type (e.g., “Ketchup”)
modifier—the entire modifier. Equivalent to %modType%%modName%
itemQuantity—the quantity of the currently indicated item
modQuantity—the quantity of the current modifier (as above) for this element
<modifier-group-name>—a variable is instantiated for each modifier group. A modifier group is associated with each “Pick1” option group. The name of the group is used for the variable name (e.g., “Size”), while the selected value (e.g., “Regular”) replaces the variable.

The final step in the order mapping process is to take each of the items and modifiers produced by the execution of the rules' actions and map their textual tags to efficient keys for identifying the items within the point-of sale (POS) or receiving system. These may be, for example, price look-ups (PLUs). If a map is not found for an entry, it is returned verbatim. This allows a null mapping of some or all entries.

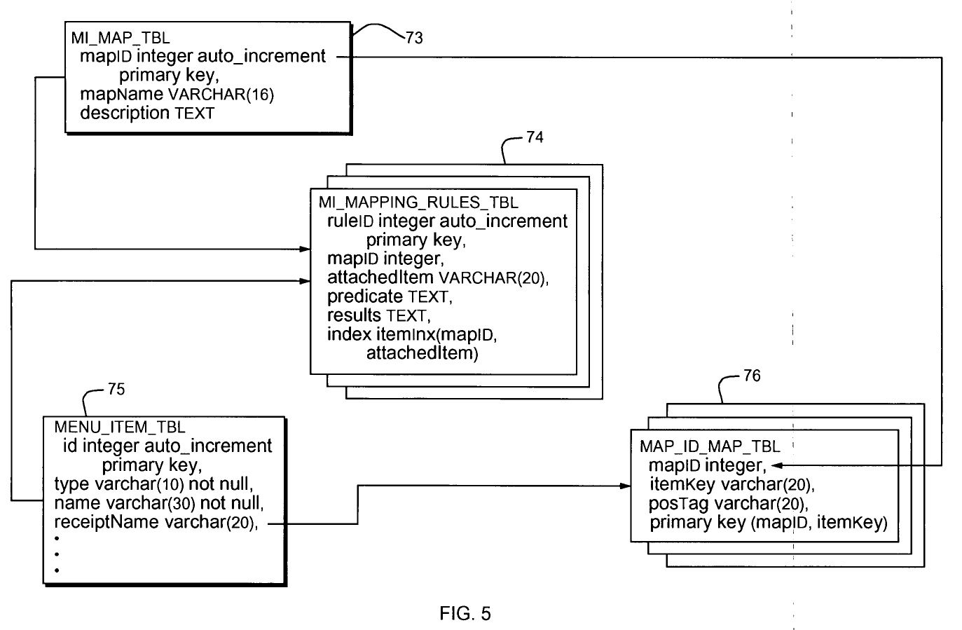

FIG. 5 describes the data structure of the mapping system. In FIG. 5, MI_MAP_TBL 73 is a table that stores multiple mapIDs. MI_MAP_TBL 73 inputs a single mapiD into MI_MAPPING_RULES_TBL 76 to retrieve a set of mapping rules, and inputs the same mapID into MI_ID_MAP_TBL 76 for translating item tags. MENU_ITEM_TBL 75 contains menu items, but maps only one menu item to MI_MAPPING_RULES_TBL 74 for the application of the mapping rules for that item, and the same item to MI_IDMAP_TBL 76 for the translation of the textual tags. Thus, the integration of the data structure is explained.

Further details about one embodiment of the exemplary order mapping system are described below.

Name: Order Mapping Service

Type: Web Service (SOAP RPC)

Interfaces:
Map OrderItems (orderitems) returns (posOrderItems) Note:
orderitems is defined in the schema below.
posOrderItems is syntactically similar to orderitems, but as it can be semantically dissimilar, is given it's own data type.

Schemas:

```
<schema>
  <complexType name=’orderItems’>
    <complexType name=’ orderItem’ minOccurs= 1>
      <element name=’itemName’ type=’string’ />
      <element name=’itemPrice’ type=’float’ />
      <element name’itemQuantity’ type=’integer’
        minOccurs=0 maxOccurs1 />
      <complexType name=’modifier’
          type=’modifierType’ minOccurs=0 />
        <element name=’modName’ />
        <element name’modPrice type=’float’ />
        <simpleType name=’modType=’base’xsd:
            string’>
          <enumeration value=’add’ />
          <enumeration value=’hold’ />
          <enumeration value=’choose’ />
        </simpleType>
        <element name=’modQuantity’
          type=’integer’
            minOccurs=0
            maxOccurs= 1 />
      </complexType>
    </complexType>
  </complexType>
  <complexType name=’posOrderItems’>
    <complexType name=’orderItem’ minOccurs=1>
      <element name=’itemName’ type=’string’ />
        <element name=’itemPrice’ type=’float’ />
        <element name=’itemQuantity’ type=’integer’
          minOccurs=0 maxOccurs=1 />
        <complexType name’modifier’ type=’
          modifierType’ minOccurs=0 />
        <element name=’modName’ />
        <element name’modPrice type=’float’ />
        <element name=’modQuantity’ type=’integer’ m
            minOccurs=0
            maxOccurs=1 I>
      </complexType>
    </complexType>
  </complexType>
</schema>
```

### Examples of Semantic Mapping

Using the exemplary restaurant model and assuming a user is ordering remotely from the restaurant location (i.e. over the internet), a user decides to order a burger from a particular restaurant at a particular location. The user inputs the type of burger they want, e.g., with cheese, no onions, etc., and the restaurant and location where the burger is to be picked up. The order mapping system 10 of the present invention uses the restaurant and location information entered by the user to locate a set of mapping rules, and applies those rules to the items array containing information about the type of burger the user ordered. Finally, the mapping system outputs an items array for the burger the user ordered to the restaurant's receiving system in a format the receiving system recognizes. The restaurant's receiving system will then output an order (to a screen or a paper slip) in a form known and recognized by workers at the restaurant to prepare and package the order. This step and consistency is important since a significant effort is always undertaken to train and familiarize restaurant workers with the proper methods of preparing an order base on the information output by the restaurant's particular receiving system.

The following rule sets illustrate an exemplary hierarchy for realizing the functional examples in FIG. 2 (the example numbers below correlate with the numbers in FIG. 2).

Default Rules (Attached at top of hierarchy)
# Emit and consume any remaining items verbatim TRUE→Emit “%itemName%”; Consume “%itemName%” # Emit and consume any remaining modifiers verbatim hasModifier(‘+*’)→EmitMod %modName%; ConsumeMod

%modifier%

### EXAMPLE #1

```
  ofType(“Burger”) →Emit Burger SM; Consume Burger
  hasModifier(+Onions) →EmitMod Has Onions;
Consume+Onions
```

### EXAMPLE #2

ofType(“Burger”) →Emit Burger SM; Consume +Onions;
Consume Burger

### EXAMPLE #3

```
  ofType(“Burger”) and not hasModifier(“+Onions”) →Emit
Burger;
  EmitMod
    Hold Onions; Consume Burger
```

### EXAMPLE #4

```
  ofType(“Burger Combo”) →Emit Burger; ConsumeMod
+Onions;
  ofType(”Combo”) and hasModifier(”=Super Size”) →
    Emit Ex Lg %Beverage%;
    ConsumeMod %Beverage%;
    Emit “Super Fries”;
    ConsumeMod =Super Size;
    Consume Burger Combo
```

### EXAMPLE #5 (ATTACHED TO COFFEE)

```
  selectionOf(“Flavor”) == “Hazelnut” →Emit Hazelnut
Coffee;
    ConsumeMod =Hazelnut
  hasModifier(“+Sugar”) →EmitMod Sugar; ConsumeMod Sugar
  hasModifier(“+Cream”) →EmitMod H+H; ConsumeMod Cream
  TRUE→Consume Coffee
```

### EXAMPLE #6 (ATTACHED TO COFFEE)

```
  selection(“Flavor”) == “Hazelnut” and
selection(”Style”) ==
  “Decaff’→
    Emit Decaff HN Coffee; ConsumeMod Hazelnut;
      ConsumeMod Decaff; Consume Coffee
```

### EXAMPLE #7 (ATTACHED TO “DOZEN DONUTS”)

```
  hasModifier(“*”) and modQuantity()> 1 →
      Emit %modQuantity% %modName% Donuts;
        ConsumeMod %modifier% | %modQuantity%
    hasModifier(”*”) and modQuantity() == 1 →Emit
%modName% Donut;
        ConsumeMod %modifier%
      TRUE → Consume Dozen Donuts
```

### Syntactic Mapping

An exemplary method of syntactic mapping will be now described. The mapping system 10 according to the present invention provides a common interface between the input system 12 and the location's receiving system 18 instantiating a particular point of sale integration module based on the configuration of the receiving system, and relays all of the service calls to that receiving system. The mapping system 10 details are given below.

Name: POS Integration Service

Type: Web Service (SOAP RPC)

Interfaces:
(posOrderltems) returns (Error, Subtotal, Tax)
Submit (terminalTag, posOrderItems, paymentInfo) returns (Error, Subtotal, Tax, orderTag)

Schemas: (defined above)

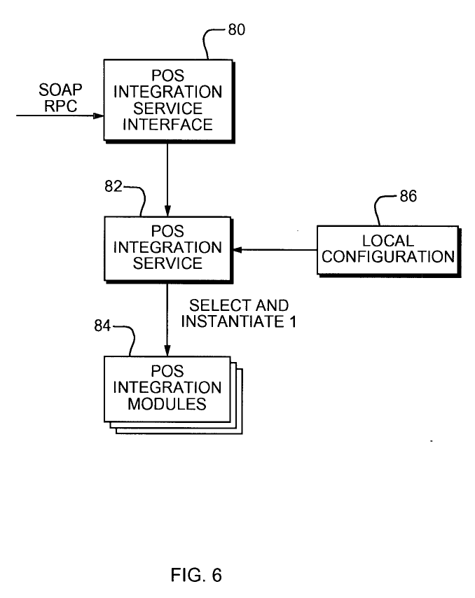

As shown in FIG. 6 and the system details above, the posIntegrationService 82 provides a generic class that provides a common callable interface 80 to any POS Integration Module 84. A well-known instance of the posIntegrationService (THE_POSIS) is instantiated as a global variable within the module. During instantiation, POSIS consults the local configuration file 86 to determine the name of the POS Integration Module to use for this site. That named module is then imported and an instance of a POS Integration Manager is constructed. All of the requests received by this module will, thereafter, be relayed to that POS Integration Manager. All POS Integration Managers are derived from a base class: posIMBase.manager.

The present invention is not intended to be limited to a device or method which must satisfy one or more of any stated or implied objects or features of the invention and is not intended to be limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claimed is:

1. An order mapping system, comprising:
an order input system having a user interface, for receiving an order of one or more items from a user, and for providing an order data stream, said order data stream including at least order information providing an indication of said one of more items ordered by said user and a vendor order processing system identifier identifying the vendor order processing system in use by a vendor who will fulfill said user's order;
a vendor order processing system in use by said vendor who will fulfill said user's order, for receiving vendor order processing system formatted order data and for providing at least a visual indication of an order to be fulfilled; and
an order mapping engine, coupled to said order input system and to said vendor order processing system in use by said vendor who will fulfill said user's order, for receiving said order data stream including said vendor order processing system identifier, and responsive to said vendor order processing system identifier, for converting said order information into said vendor order processing system formatted order data for use by said vendor order processing system in use by said vendor who will fulfill said user's order.

2. The order mapping system of claim 1 wherein said order information includes at least an item identifier.

3. The order mapping system of claim 1 wherein said order information includes and at least one item modifier.

4. The order mapping system of claim 1 wherein said order mapping engine performs of or more conversions from the set of mappings consisting of: map one item name to a different item name; map a modifier type to a modifier tag; map a modifier type to a null modifier; map a single item tag to multiple item tags; map a combination of an item tag and modifiers to multiple specific item tags, with or without modifiers; map an item or modifier with a quantity to multiple items of the same type; map an item with a particular set of modifiers to a single item definition; and map an item with a set of quantified modifiers to a set of quantified items.

5. The order mapping system of claim 1 wherein said vendor order processing system is a point-of-sale system.

6. The order mapping system of claim 5 wherein said point-of-sale system tracks item inventory for said vendor.

7. The order mapping system of claim 5 wherein said point-of-sale system tracks purchases by a user.

8. The order mapping system of claim 1 wherein said visual indication of an order to be fulfilled includes a visual indication on an electronic display screen of the order to be fulfilled.

9. The order mapping system of claim 1 wherein said visual indication of an order to be fulfilled includes a printed indication of the order to be fulfilled.

10. The order mapping system of claim 2 wherein said at least one item identifiers have a hierarchical relationship to one another.

11. The order mapping system of claim 1 wherein said order mapping engine consumes on entry in said order data stream and emits said vendor order processing system formatted order data for use by said vendor order processing system in use by said vendor who will fulfill said user's order.

12. An order mapping system, comprising:
an order input system having a user interface, for receiving an order of one or more items from a user, and for providing an order data stream, said order data stream including at least order information providing an indication of said one of more items ordered by said user and a vendor order processing system identifier identifying the vendor order processing system in use by a vendor who will fulfill said user's order, said order information including at least one ordered item identifier and at least one ordered item modifier;
a vendor order processing system in use by said vendor who will fulfill said user's order, for receiving vendor order processing system formatted order data and for providing at least a visual indication of an order to be fulfilled; and
an order mapping system, coupled to said order input system and to said vendor order processing system in use by said vendor who will fulfill said user's order, for receiving said order data stream including said vendor order processing system identifier, and responsive to said vendor order processing system identifier, for converting said order information including said at least one ordered item identifier and at least one ordered item modifier into said vendor order processing system formatted order data including at least one ordered item identifier and at least one ordered item modifier for use by said vendor order processing system in use by said vendor who will fulfill said user's order.

13. An order mapping system, for mapping ordered data information from an order input system to a specified vendor order processing system in use by a vendor who will fulfill a user's order, the vendor order processing system for receiving vendor order processing system formatted order data and for providing at least a visual indication of an order to be fulfilled, the order mapping system comprising:
an order input system having a user interface, for receiving an order of one or more items from a user, and for providing an order data stream, said order data stream including at least order information providing an indication of said one of more items ordered by said user and a vendor order processing system identifier identifying the vendor order processing system in use by a vendor who will fulfill said user's order; and
an order mapping system, coupled to said order input system and to said vendor order processing system in use by said vendor who will fulfill said user's order, for receiving said order data stream including said vendor order processing system identifier, and responsive to said vendor order processing system identifier, for converting said order information into said vendor order processing system formatted order data for use by said vendor order processing system in use by said vendor who will fulfill said user's order.
